(19) United States
(12) Patent Application Publication
(10) Pub. No.: US 2010/0217889 A1
(43) Pub. Date: Aug. 26, 2010

(54) ACCELERATED BLOCK OPTION FOR TRIVIAL FILE TRANSFER PROTOCOL (TFTP)

(75) Inventors: Nathaniel John Simcoe, Phoenix, AZ (US); Steven James Darr, Phoenix, AZ (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/393,482

(22) Filed: Feb. 26, 2009

(51) Int. Cl. G06F 15/16

(52) U.S. Cl. 709/237

(57) ABSTRACT

Systems and methods for improved data transfers are provided. In one embodiment, a computer readable data storage device having computer executable code for a method for an accelerated file transfer protocol is provided. The method comprises: determining a number (N) of data blocks for accelerating a sending device ahead of a receiving device; transmitting an initial data block plus N additional data blocks to the receiving device without waiting for an acknowledgement (ACK) message from the receiving device; checking for receipt of an ACK message; when a correct ACK message is received, transmitting a next data block; and when a final data block is transmitted, verifying receipt of an ACK message for each of a last N transmitted data blocks.

### BACKGROUND

Commercial aviation systems are being designed to load their operational software via the Aeronautical Radio, Incorporated (ARINC) 615A specification, which uses the Trivial File Transfer Protocol (TFTP) as defined by RFC 1350. On a fast network, TFTP is a satisfactory file transfer protocol. On a slow network, TFTP becomes bogged down due to the Data/Acknowledgement (ACK) handshake between the client and server. The issue is the ARINC 615A TFTP communication is being performed on a secure aircraft network where the loading paths are not given enough bandwidth to support the amount of data transferred. This is the case since the network bandwidth is mostly dedicated to flying the airplane. This combination of TFTP and a slow aircraft network causes the software load times to increase dramatically, thus increasing the aircraft downtime. Other commercial systems have solved this issue by going to a different file transfer protocol, but changing file transfer protocols for this application is not possible due to the ARINC 615A definition.

For the reasons stated above and for other reasons stated below which will become apparent to those skilled in the art upon reading and understanding the specification there is a need in the art for methods and systems for improved data transfers.

### SUMMARY

The Embodiments of the present invention provide methods and systems for an accelerated block option for TFTP file transfers and will be understood by reading and studying the following specification.

In one embodiment, a computer readable data storage device having computer executable code for a method for an accelerated file transfer protocol is provided. The method comprises: determining a number (N) of data blocks for accelerating a sending device ahead of a receiving device; transmitting an initial data block plus N additional data blocks to the receiving device without waiting for an acknowledgement (ACK) message from the receiving device; checking for receipt of an ACK message; when a correct ACK message is received, transmitting a next data block; and when a final data block is transmitted, verifying receipt of an ACK message for each of a last N transmitted data blocks.

### DRAWINGS

Embodiments of the present invention can be more easily understood and further advantages and uses thereof more readily apparent, when considered in view of the description of the preferred embodiments and the following figures in which:

FIGS. 1A and 1B illustrate Accelerated TFTP request packets of one embodiment of the present invention;

FIG. 2 is flow chart illustrating a method for initiating an accelerated file transfer of one embodiment of the present invention;

FIG. 3 is flow chart illustrating a method for an accelerated file transfer of one embodiment of the present invention;

FIG. 4 is flow chart illustrating a method for data recovery for an accelerated file transfer of one embodiment of the present invention;

FIGS. 5A and 5B illustrate non-accelerated verses accelerated file transfer timelines;

FIG. 6 is a block diagram of client and server devices of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention define an option for TFTP that accelerates a TFTP file transfer thus reducing the overall file transfer time. Current operations of TFTP are not altered. Instead, embodiments of the present invention expand upon it. With embodiments of the present invention, an initial set of one or more data blocks are sent early. That is, a data block is transmitted without waiting for the corresponding ACK for the previously transmitted block. This allows the sender to keep its transmit line continuously full of data, instead of sending a block of data and then going idle while waiting for the corresponding ACK. TFTP remains the primary protocol managing the file transfer, so systems that don't support the new option are still compatible with systems that do. Embodiments of the present invention thus have the benefit of expanding upon the existing TFTP transfer protocols instead of creating a whole new file transfer protocol. Thus, embodiments of the present invention are applicable to any instance of TFTP implementation.

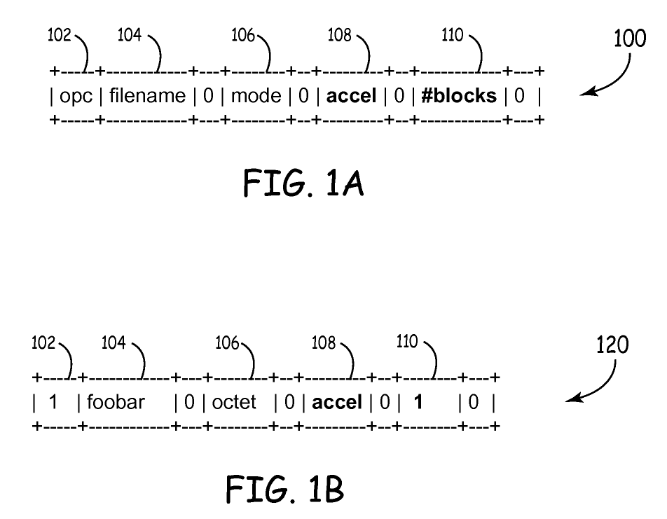

FIG. 1A illustrates a TFTP request packet 100 of one embodiment of the present invention. The TFTP request packet 100 provides an expansion to a standard TFTP request packet by introducing the acceleration option explained herein. As shown in FIG. 1, TFTP request packet 100 comprises an opcode field (opc) 102, a filename field 104 and a mode field 106. The opcode filed 102 will contain a 1 for a file read request (RRQ) and a 2 for a file write request (WRQ). The filename field 104 will contain the name of the file to be read or written. The mode field 106 specifies the mode of the file transfer (for example, “netascii”, “octet”, or “mail”).

TFTP request packet 100 further comprises an acceleration option field 108 that, when the acceleration option is requested, indicates such by including, for example, the term “accel” or other predetermined option indicator. The “#blocks” field 110, when the acceleration option is selected, indicates a number (“N”) of TFTP blocks the file transfer will be ahead. That is, the value N in “#blocks” field 110 indicates the number of additional blocks that will be initially transmitted by the transmitter, without pausing to wait to receive corresponding “ACK” messages from the receiver.

FIG. 1B, shown at 120 is one example of an implementation of TFTP request packet 100 discussed in FIG. 1A. In FIG. 1B, TFTP request packet 120 is a read request (indicated by opcode field 102), for a file named “foobar” (indicated by filename field 104), in octet (binary) transfer mode (indicated by mode field 106), with an acceleration option selected (indicated by acceleration option field 108) of 1 block (indicated by #blocks field 110). TFTP request packet 120 is sent by a client to a server to initiate the file transfer. Additional information regarding TFTP protocol options extensions can be found in Internet Engineering Task Force (IETF) Request for Comments (RFC) number 2347, which is incorporated herein by reference.

If the server is willing to accept the acceleration option, it sends an Option Acknowledgement (OACK) to the client. The server may transmit back to the client a Option Acknowledgement (OACK) that indicates that the server is willing to accelerate based on the #blocks value 110 specified by the client. Alternatively, the server may transmit back to the client an Option Acknowledgement (OACK) that indicates the server will grant the acceleration option, but at an acceleration less than the value specified by the client.

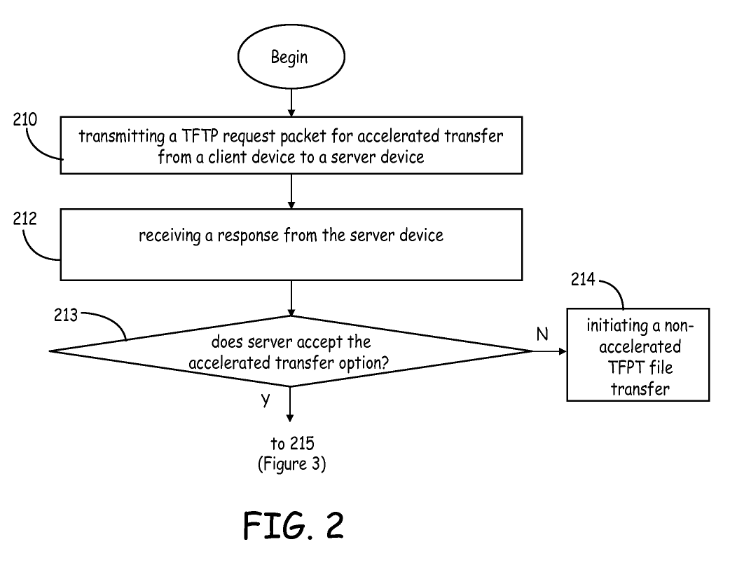

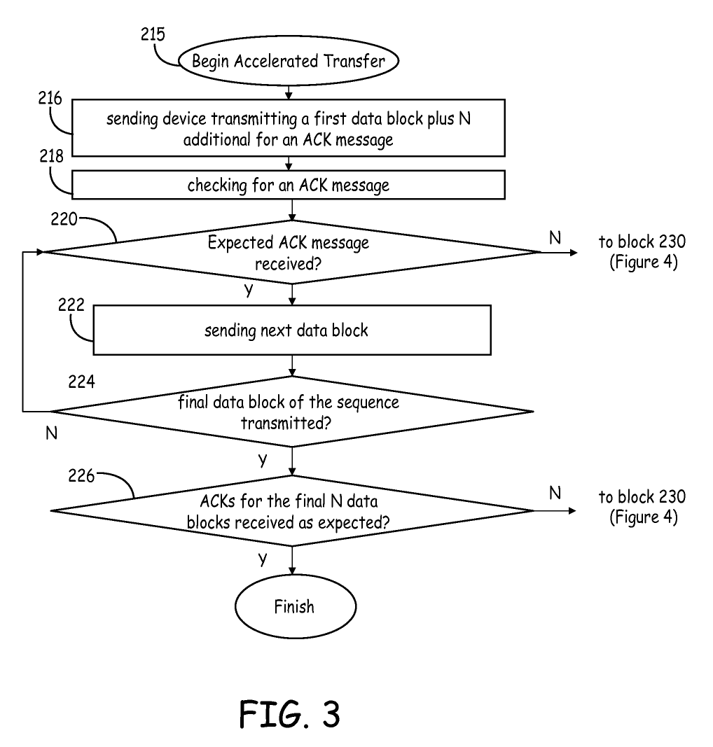

FIG. 2 is a flow chart illustrating a method for implementing the accelerated TFTP protocol file transfer of one embodiment of the present invention. The method begins at 210 with transmitting a TFTP request packet for accelerated transfer (that is, with an acceleration option selected) from a client device to a server device. The method proceeds to 212 with receiving a response from the server device. The response is evaluated at block 213. If the Option Acknowledgement (OACK) indicates that the server accepts the accelerated transfer option with the block count requested by the client, the method proceeds to 215 (shown in FIG. 3) to begin the accelerated file transfer. As discussed above, an Option Acknowledgement (OACK) may accept accelerated transfer at the #blocks value requested in the TFTP request packet. Alternatively, the Option Acknowledgement (OACK) may indicate that accelerated transfer may proceed at a #blocks value less than that requested in the TFTP request packet. In the latter case, the method also proceeds to 215 and the value of “N” would be the #blocks value approved by the server in the Option Acknowledgement (OACK). If no Option Acknowledgement (OACK) or an Option Acknowledgement (OACK) without the accelerated transfer option is received in response to the TFTP request, that indicates that the server has rejected (or otherwise does not recognize) the request for an accelerated transfer, the method proceeds to 214 with initiating a non-accelerated TFTP file transfer. Reception of an ACK packet in response to a TFTP write request, or a DATA packet in response to a TFTP read request would also indicate that the accelerated transfer option was either rejected or not recognized by the server. In both of those cases, the method would also proceed to 214 to initiate a non-accelerated TFTP transfer. The method of FIG. 2 thus illustrates a process for determining the number (N) of data blocks for accelerating the sending device ahead of the receiving device and as described above, this determination may further comprise a negotiation between the sending device and the receiving device for determining N.

FIG. 3 is a flow chart illustrating a method for transferring a file using the accelerated TFTP protocol file transfer of one embodiment of the present invention. The method shown in FIG. 3 provides for a file transfer wherein the sending device (that is, the device sending the file) will accelerate data block transmissions by the #blocks value N determined by the method of FIG. 2. In one implementation, when the TFTP request packet is a read request, the sending device will be a server while the receiving device will be a client. Likewise, when the TFTP request packet is a write request, the transmitting device will be a client while the receiving device will be a server. The method thus proceeds to 216 with the sending device transmitting a first data block plus N additional data blocks (in other words, N+1 data blocks total) to the receiver without waiting for an acknowledgement (ACK) from the receiving device. That is, the sending device will transmit each of the N+1 data blocks consecutively at a rate dictated by the transmission medium and will not pause between data blocks to wait for an ACK message from the receiver. For example, if the #blocks value of N is 2, the transmitter will transmit 3 consecutive data blocks as just described. Block 216 thus places the sending device N data blocks ahead of the receiving device.

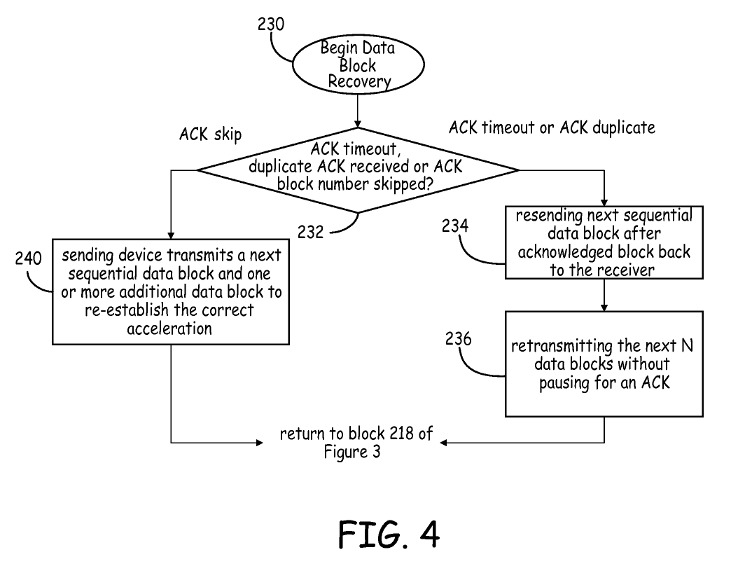

The method proceeds to block 218 with checking for an ACK message. With the sending device now accelerated ahead of the receiving device by the desired number of data blocks, the file transfer now proceeds by sending one data block per ACK message received. Thus when an expected ACK message is received (checked at 220), the method proceeds to 222 with sending another data block, until the final data block of the sequence is transmitted (checked at 224). For example, after transmitting the first data block plus N additional data blocks, the sending device will pause until it receives an ACK indicating that the first data block was successfully received by the receiving device. The sending device would then transmit data block N+2. The sending device next expects to receive an ACK with a data block number of 2 from the receiver. Upon receiving the ACK for data block 2, the sending device would then transmit data block N+3. Assuming no errors take place, when the sending device receives an ACK with a data block number of M, it will next transmit data block M+N+1 to the receiver until the last data block is transmitted. At that point, the method proceeds to 226 with verifying receipt of ACKs for the last N data blocks. When an expected ACK message is not received (either at 220 or 226), the method proceeds to block 230 for data recovery as discussed with respect to FIG. 4 below.

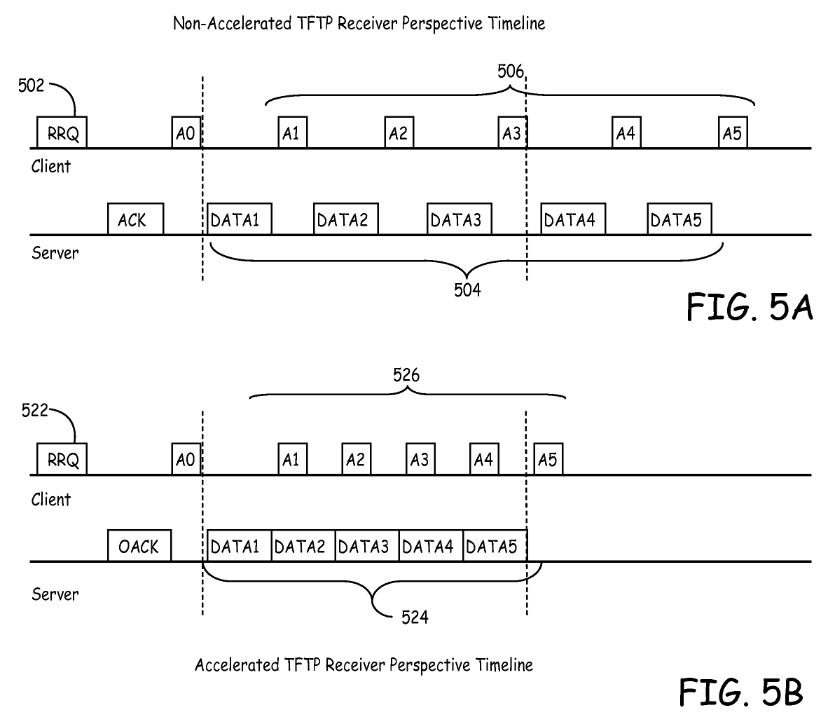

By having the sending device multiple blocks ahead of the receiver, the network overhead of waiting for an ACK response for each data block is removed. This accelerates the transfer of an entire file as illustrated by FIGS. 5A verses 5B.

As shown in FIG. 5A, when a client sends a TFTP request packet 502 to receive a file from a server without acceleration, the data blocks it receives from the server (shown generally at 504) are delayed in time because the client must acknowledge each block by transmitting ACK messages back to the server (shown generally at 506) before the server will transmit the next data block.

In contrast, for embodiments of the present invention, such as the example shown in FIG. 5B, when a client sends a TFTP request packet for accelerated transfer 522 (with N=1 for this example) to receive a file from a server, the data blocks it receives from the server (shown generally at 524)are not delayed in time. The client still transmits ACK messages back to the server that identify received data blocks (shown generally at 526), but the next data block is already available in the client's input queue because it had already been transmitted by the server. Since the client processes the inbound data serially, it will receive the first data block (DATA 1), process DATA 1, and send an ACK for the first block (A1). This accomplished while the second data block (DATA 2) is being received by the client's hardware, or even while it has already been received, and it is sitting in the input queue waiting to be processed. Right after the A1 is transmitted to acknowledge receipt of DATA 1, the client will find the second data block (DATA 2) already in its input queue. To the client, the transmission of acknowledgement A1 and the reception of DATA 2 were almost instantaneous. This pre-transmission pushes data blocks onto the server transmit line to enhance utilization. In addition, the larger the file, the greater the benefit. From the server's perspective, the server would send DATA 2 right after it sends DATA 1 at the start of a TFTP file transfer. Upon receiving A1, the server would be ready to send DATA 3 instead of DATA 2, because DATA 2 was already transmitted. By staying at least N blocks ahead, the server is making the assumption the preceding blocks were received by the client.

Returning to FIG. 3, when an expected ACK message is not received (either at 220 or 226), the method proceeds to block 230 of FIG. 4. When the receiving device fails to receive the next expected data block in the sequence, it waits for a time-out period to re-transmit the ACK of the last data block it successfully received. The receiver would then empty its input queue to throw away any data blocks that have a block number greater than the block number the receiving device was expecting (these are the blocks the sending device has pre-transmitted) while it waits for the retransmission of the missing data block. In an alternate embodiment, when the receiving device is expecting the next data block in the sequence to be data block X and instead it next receives data block X+1, the receiving device can use the receipt of data block X+1 to indicate a failed reception of the data block X. The receiving device thus can re-transmit the ACK of data block X immediately upon reception of the data block X+1 instead of waiting for the full timeout period.

FIG. 4 thus illustrates a data recovery process method for transferring a file using the accelerated TFTP protocol file transfer of one embodiment of the present invention beginning at 230. When the sending device receives a duplicate ACK from the receiver (checked at 232), the method proceeds to 234 with resending the next sequential data block after the acknowledged block back to the receiver. For example, should the sending device receive an ACK for data block 12 followed by another ACK for data block 12, the sending device will respond by resending data block 13. To reestablish acceleration, the method proceeds to 236 with also retransmitting the next N blocks without pausing to wait for an ACK. This places the sender back ahead of the receiver. The method then returns to block 218 of FIG. 3.

If an ACK packet transmitted by a receiving device is lost or corrupted, there is no effect on the receiving device because it will already have the next data block ready in its input queue for processing. The sending device however will see a skip in the block numbers associated with the ACK packets. In this case, the sending device would have to recognize that it was no longer N blocks ahead of the client. In response to the ACK received, the sending device would transmit the next data packet and pre-ship one or more additional data blocks to re-establish the correct acceleration. For example, if the #blocks value of N is 2 for a file transfer and the sending device is expecting an ACK for data block 10, normally it would respond by transmitting data block 13. If instead it receives an ACK for data block 11, the sending device would transmit data block 13 and also pre-ship data block 14 without pausing to wait for an ACK. This would re-establish the sending device at the correct acceleration of 2 blocks ahead of the receiver. Similarly, if the above sending device expecting an ACK for data block 10 instead receives an ACK for data block 12, the sending device would transmit data block 13 and also pre-ship data blocks 14 and 15 without pausing to wait for an ACK.

Thus, the method further includes at 232 checking for a skip in ACK block numbers. If an ACK message skip occurs, the method proceeds to 240 where the sending device transmits a next sequential data packet and one or more additional data block to re-establish the correct acceleration. The method then returns to block 218 of FIG. 3.

It is also possible for errors to occur during the process of pre-transmitting data blocks. Accordingly, in one embodiment the sending device looks for ACKs from the receiver while establishing the correct acceleration, even though it does not wait (i.e. pause) for the ACKs when pre-transmitting the N additional data blocks. If an ACK message error occurs while attempting to reach the maximum accelerated block value (e.g., a duplicate ACK message, an out of sequence ACK message, or an exceeded ACK timeout period) the sending device will proceed as described in FIGS. 3 and 4 without transferring further accelerated blocks. This may occur in situations where the accelerated block value is larger than the network bandwidth.

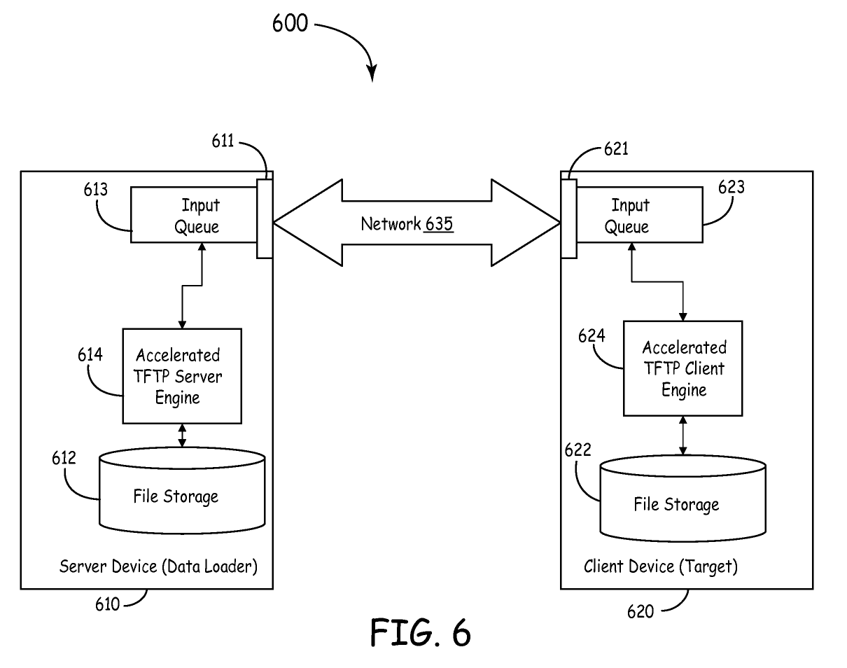

FIG. 6 is a block diagram illustrating a system 600 of one embodiment of the present invention. System 600 includes a server device 610 and a client device 620 coupled to communicate over a network 635. Network 635 may comprise devices for establishing either wired or wireless communication links and may further comprise one or more network components such as, but not limited to, routers, gateways, switches and physical connection interfaces.

Server device 610 comprises a storage device 612 for storing files, an input queue 613 for storing data blocks received from a network interface 611 coupled to network 635, and an Accelerated TFTP Server Engine 614. In one embodiment, input queue comprises a 16k buffer. In one embodiment, Accelerated TFTP Server Engine 614 is implemented as a software module executed by a controller or a processor. In alternate embodiments, Accelerated TFTP Server Engine 614 is implemented through dedicated hardware. In one embodiment, Accelerated TFTP Server Engine 614 operates as described above for FIGS. 1-5 for sending and receiving files using the accelerated TFTP protocol described above.

Client device 620 comprises a storage device 622 for storing files, an input queue 623 coupled to a network interface 621 coupled to network 635, and an Accelerated TFTP Client Engine 624. In one embodiment, input queue comprises a 16k buffer. In one embodiment, Accelerated TFTP Client Engine 624 is implemented as a software module executed by a controller or a processor. In alternate embodiments, Accelerated TFTP Client Engine 624 is implemented through dedicated hardware. In one embodiment, Accelerated TFTP Client Engine 624 operates as described above for FIGS. 1-5 for sending and receiving files using the accelerated TFTP protocol described above.

For example, in one embodiment client device 620 is an avionics computer for an aircraft and server device 610 is a data-loader device for loading operational software onto client device 620 using ARINC 615A. Client device 620 is thus a target device with which the data-loader 610 transfers files. Network 635 is an avionics network that allocates a data pipe to facilitate file transfers between the server 610 and the client 620. In one embodiment, the avionics network provides a bidirectional full duplex Ethernet connection between server 610 and client 620. Embodiments of the present invention enable server 610 and client 620 to reduce the time required to transfer files without the need to increase the bandwidth of the data pipe. For loading files onto the server 610, the client 620 pushes data blocks into the data pipe on an accelerated basis. That is it will transmit an initial data block plus one or more additional data blocks without waiting to receive acknowledgements. Similarly, when client 620 requests a file from server 610, the server 610 pushed data blocks into the data pipe on an accelerated basis.

If the server 610 does not support accelerated TFTP or for some other reason rejects an accelerated TFTP request from client 620 (for example, by not responding to a TFTP request for an accelerated option), then client 620 can revert to a non-accelerated TFTP file transfer.

Several means are available to implement the systems and methods of the current invention as discussed in this specification. These means include, but are not limited to, digital computer systems, microprocessors, general purpose computers, programmable controllers and field programmable gate arrays. Therefore other embodiments of the present invention are program instructions resident on computer readable storage media which when implemented by such devices, enable the controllers to implement embodiments of the present invention. Computer readable media include any form of computer data storage device, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions and code include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A computer readable data storage device having computer executable code for a method for an accelerated file transfer protocol, the method comprising:
determining a number (N) of data blocks for accelerating a sending device ahead of a receiving device;
transmitting an initial data block plus N additional data blocks to the receiving device without waiting for an acknowledgement (ACK) message from the receiving device;
checking for receipt of an ACK message;
when a correct ACK message is received, transmitting a next data block; and
when a final data block is transmitted, verifying receipt of an ACK message for each of a last N transmitted data blocks.

2. The computer readable data storage device of claim 1, wherein when a correct ACK message is received, transmitting a next data block further comprises:
verifying that consecutively received ACK message are associated with sequentially consecutive data blocks.

3. The computer readable data storage device of claim 1, wherein when a correct ACK message is received, transmitting a next data block further comprises:
verifying that consecutively received ACK message are received within a timeout period.

4. The computer readable data storage device of claim 1, the method further comprising:
when a correct ACK message is not received, executing a data recovery.

5. The computer readable data storage device of claim 4, wherein executing a data recovery further comprises:
when a duplicate ACK message is received from the receiving device for an acknowledged data block, resending a next sequential data block after the acknowledge data block plus a next N sequential data blocks without waiting to receive an ACK message from the receiving device.

6. The computer readable data storage device of claim 4, wherein executing a data recovery further comprises:
checking for a skip in received ACK message block numbers
when a skip in received ACK message block numbers is identified,
transmitting a next sequential data block and at least one additional data block to accelerate the sending device ahead of the receiving device by N data blocks.

7. The computer readable data storage device of claim 1, the method further comprising:
when a next expected data block is not received within a timeout period, re-transmitting a duplicate ACK message that indicates a last successfully received data block; and
emptying from an input queue one or more data blocks having a block number greater than a block number of the next expected data block.

8. The computer readable data storage device of claim 1, the method further comprising:
transmitting a TFTP request message to a server device requesting an accelerated transfer and a number of data blocks to accelerate, and
checking for an Option Acknowledgement (OACK) from the server device.

9. The computer readable data storage device of claim 8, wherein the TFTP request message is one of either a file read request and a file write request.

10. The computer readable data storage device of claim 8, the method further comprising:
when the Option Acknowledgement (OACK) is not received from the server within a timeout period, proceeding with a non-accelerated file transfer; and
when the Option Acknowledgement (OACK) does not indicate acceptance of the accelerated transfer, proceeding with a non-accelerated file transfer.

11. The computer readable data storage device of claim 1, wherein the number (N) of data blocks for accelerating the sending device ahead of the receiving device is based on an Option Acknowledgement (OACK) to a TFTP request message requesting an accelerated transfer.

12. The computer readable data storage device of claim 1, wherein determining a number (N) of data blocks for accelerating a sending device ahead of a receiving device further comprises a negotiation between the sending device and the receiving device.

13. A data loader device for transferring files with a client, the data loader device comprising:
an interface for coupling with an avionics network having a client;
a file storage device; and
an Accelerated TFTP Server Engine for loading files from the file storage device onto the client via the avionics network, wherein the Accelerated TFTP Server Engine, after transmitting an initial data block, pre-transmits N subsequent data blocks without waiting for an acknowledgement (ACK) message for a prior transmitted data block.

14. The data loader device of claim 13, wherein the Accelerated TFTP Server Engine maintains transmission of data blocks N data blocks ahead of received ACK messages.

15. The data loader device of claim 13, wherein the Accelerated TFTP Server Engine transmits an initial data block of a file, plus the N subsequent data blocks of the file to the client without waiting to receive an acknowledgement (ACK) message from the client.

16. The data loader device of claim 13, wherein the Accelerated TFTP Server Engine verifies that consecutively received ACK messages from the client are associated with sequentially consecutive data blocks transmitted to the client;
wherein when a duplicate ACK message is received from the client for an acknowledged data block, the Accelerated TFTP Server Engine resends a next sequential data block after the acknowledge data block plus a next N sequential data blocks without waiting for an ACK message from the client; and
when the Accelerated TFTP Server Engine observes a skip in received ACK message block numbers, the Accelerated TFTP Server Engine transmits a next sequential data block and at least one additional data block to accelerate the data loader device ahead of the client by N data blocks.

17. The data loader device of claim 13, further comprising a processor executing program instructions for the Accelerated TFTP Server Engine.

18. A client device for an avionics network aboard an aircraft, the client device comprising:
an interface for coupling with an avionics network;
an input queue for receiving data blocks from a data loader via the avionics network;
a file storage device; and
an Accelerated TFTP Client Engine for receiving a file from a data loader and saving the file to the file storage device, wherein the Accelerated TFTP Client Engine retrieves a first data block from the input queue and transmits to the data loader a acknowledgement (ACK) message that indicates the first data block was successfully received;
wherein when the Accelerated TFTP Client Engine does not retrieve a next expected sequential data block from the input queue, the Accelerated TFTP Client Engine re-transmits a duplicate ACK message for the first data block and deletes from the input queue any data blocks having a block number greater than a block number of the next expected sequential data block.

19. The client device of claim 18, wherein when the Accelerated TFTP Client Engine does not retrieve a next expected sequential data block from the input queue within a timeout period, the Accelerated TFTP Client Engine re-transmits a duplicate ACK message for the first data block and deletes from the input queue any data blocks having a block number greater than a block number of the next expected sequential data block.

20. The client device of claim 19, wherein the Accelerated TFTP Client Engine further transmits a file from the file storage device to the data loader upon receiving a TFTP request message from the data loader, wherein the Accelerated TFTP Client Engine, after transmitting an initial data block, pre-transmits at least one subsequent data block to the data loader before receiving an acknowledgement (ACK) message from the data loader for a prior transmitted data block.
